(19) United States
(12) Patent Application Publication
(10) Pub. No.: US 2008/0128096 A1
(43) Pub. Date: Jun. 5, 2008

(54) Automatic Trip Device for a Window Screen

(75) Inventors: Xiangyi Dong, Zhejiang Province (CN); Jinzhang Yu, Zhejiang Province (CN)

Correspondence Address: DLA PIPER US LLP;ATTN: PATENT GROUP, 500 8th Street, NW, WASHINGTON, DC, 20004-2131, US

(73) Assignee: Xiangyi Dong, Ningbo, Zhejiang Province (CN)

(21) Appl. No.: 11/814,052

(22) PCT Filed: Jul. 5, 2005
(86) PCT No.: PCT/CN05/00985

§ 371 Date: Aug. 3, 2007

(30) Foreign Application Priority Data
Jan. 18, 2005 (CN) 200510002236.X

(51) Int. Cl. E06B 9/24

(52) U.S. Cl. 160/90

(57) ABSTRACT

A trip device for a releasable connection between a sliding door/window and an invisible window screen comprises a screen side bar and a window sash frame at which a locking device is arranged for locking the side bar. In use, the window sash frame is pushed or pulled to translate to a window frame, and a controlling device is driven so that the locking device can be connected to the side bar. At this time, with moving the window sash, the window screen coiled in the hollow window frame can be drawn out so as to spread. When the window screen is not needed, the controlling device is driven, and the connection between the locking device and the side bar is released, then the window screen strip will automatically retract to the original state under the action of a screw torsion spring equipped at the reel.

### FIELD

The invention relates to an ancillary device of architectural materials, and more particularly to a connection device between a sash frame and an invisible movable window screen in a sliding window or door.

### BACKGROUND

A screened window or door has been widely used to prevent mosquitoes or insects from entering inhabitancy. With the popularization of a sliding door/window, a so-called invisible window screen has been developed to replace the previously used separately-installed screened sliding window/door.

Such an invisible window screen basically includes a reel and a thin window screen installed within a hollow window frame. The reel is controlled with a screw spring such that at a free state, the screen is driven to be coiled around the reel. The screen is released by a force exerted on an exposed end of the screen. Normally, the exposed end of the screen is fixed to one side of a sash frame. As such the window screen can be unwrapped while the window is opened, and wrapped back around the reel when the window is closed. Comparing with the separately-installed screened sliding window/door, the invisible window screen has a simple structure with a good appearance and is more convenient to use. However, the fixed connection between the screen and the window sash has caused some inconvenience.

An improved structure of the above device is disclosed in Chinese Patent ZL02217596.2, in which a bar-shaped groove is provided at the sash frame and a pressing bar is disposed at the exposed end of the window screen. The pressing bar is embedded within the groove, and the sash frame is releasably connected to the window screen. When there is no need to use the window screen, the pressing bar can be disassembled and the window screen is retracted to the window frame to facilitate the ventilation of the room. The improved structure has advantages that it can be conveniently used in different seasons and regions and has a pretty appearance. The shortcoming is that assembling and disassembling the pressing bar should be operated manually, which is inconvenient How to get a convenient connecting manner is still pending in the art.

### SUMMARY

The object of the invention is to provide a trip device having a movable connection between a sliding door/window and an invisible window screen.

The technical solution of the invention comprises a side bar of the window screen, a sash frame, and a locking device at the sash frame to be locked with the side bar.

The present invention can facilitate the sash frame with glass to be movably connected to an invisible window screen installed within a hollow window frame. In use, the window sash frame is pushed or pulled to the window frame to drive a controlling device such that the locking device is connected to the side bar of the invisible screen. At this time, moving the window sash frame renders the window screen wrapped within the hollow window frame being drawn out to spread. When the window screen is not needed, the controlling device is driven to disconnect the locking device and the side bar, and then the window screen will automatically be retracted to the original state under the action of a screw spring equipped at a reel. The invention has a simple structure and can be used conveniently.

### BRIEF DESCRIPTION OF THE DRAWINGS

FIG. 1 represents a schematic view of a first embodiment of the invention;

FIG. 2 represents a cutaway view of the first embodiment at an unlocked state;

FIG. 3 represents a schematic view of a second embodiment of the invention;

FIG. 4 represents a cutaway view of the second embodiment at an unlocked state;

FIG. 5 represents a schematic view of the tridimensional structure of the second embodiment at an unlocked state;

FIG. 6 represents a schematic view of the tridimensional structure of the second embodiment at an locked state; and

FIG. 7 represents a schematic view of another embodiment of the invention.

### DETAILED DESCRIPTION OF THE EMBODIMENTS

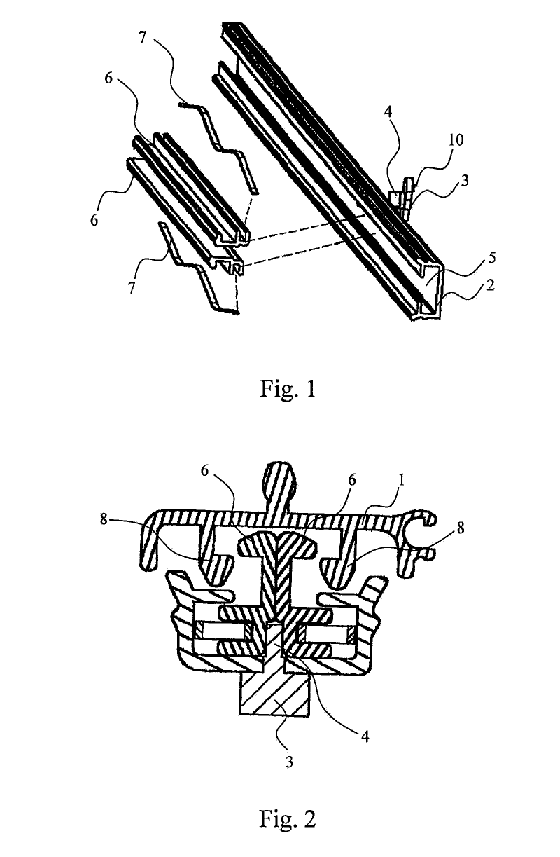

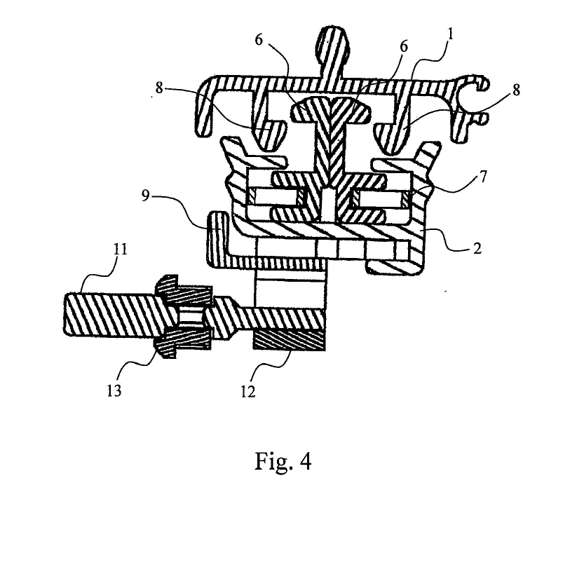

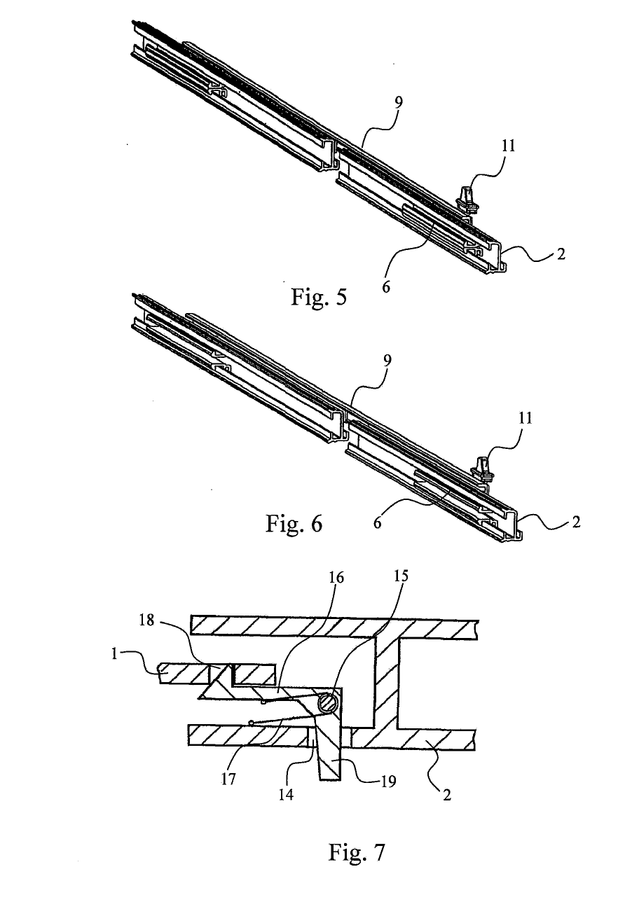

Referring to FIG. 1 through FIG. 7, an embodiment of the invention comprises a side bar 1 of an invisible window screen, a sash frame 2, and a locking device arranged at the sash frame 2 to be locked with the side bar 1. When the sash frame 2 is pushed to translate, the side bar 1 of the invisible window screen can be locked with the sash frame 2 by the locking device. When the sash frame 2 is pulled to translate again, the invisible window screen can be pulled out automatically. If the window screen is not needed, the locking device can be set at an unlocked state.

The present invention comprises at least one locking device, i.e. one or more than one locking device, which depends on the structure of the side bar 1 of the window screen or materials of the side bar provided that the side bar 1 will not be significantly deformed during the operation.

The locking device comprises a turning switch 3 having a strip-shaped turning block 4 at one end thereof. The turning block 4 is inserted into an inner chamber 5 of the sash frame 2 through a via hole at the sash frame 2. Within the inner chamber 5 are symmetrically provided two hook bodies 6, and between the hook bodies is provided a space to receive the turning block 4. A repositioning spring 7 is provided between each of the hook bodies 6 and the sash frame 2. A pair of latches 8 corresponding to the hook bodies 6 are provided at the side bar 1.

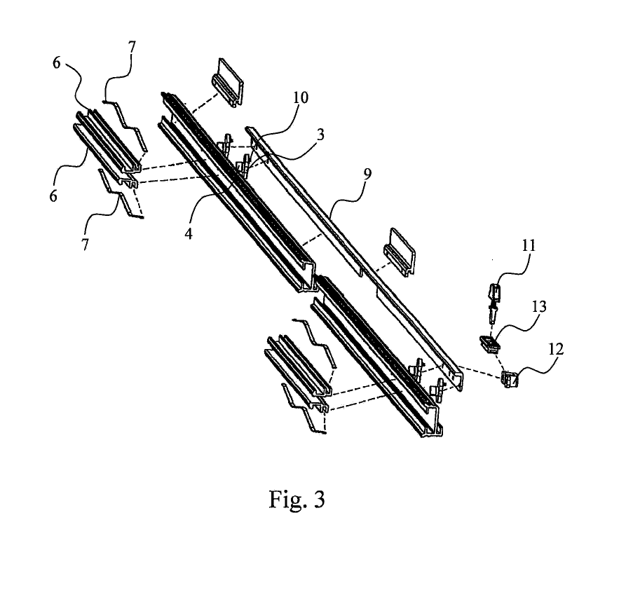

According to FIG. 2, the turning block 4 is disposed between the hook bodies 6. Under the action the repositioning spring 7, the hook bodies 6 are pushed close to each other when the locking device is at an unlocked state. Turning the turning switch 3 renders the turning block 4 to be turned accordingly, which causes the two hook bodies 6 separated as the turning block 4 has different widths in the horizontal and vertical directions. As such the hook bodies 6 are then matched with the latches 8 at the side bar 1. At this time, by pushing the sash frame 2, the invisible window screen is moved accordingly. On the contrary, when there is no need to move the window screen as the window is closed or opened, the locking device can be set at an unlocked state.

Where two locking devices are utilized, they can be disposed roughly symmetrically. In this case, there are no strict requirements on materials or strength of the side bar 1. Inexpensive materials such as plastic can be used accordingly to lower the cost of the product and to simplify the processing technique.

When there are two locking devices, the turning switch 3 should be turned twice, which causes some inconvenience. In order to make the invention more convenient, a connecting rod 9 is provided (in an embodiment) that is movably connected to a protruding member 10 at the turning switch 3. At the connecting rod 9 is provided a driving knob 11 which drives the connection rod 9 to translate. By moving the driving knob 11, the connection rod 9 is translated to drive the protruding members 10, which turn the turning switches 3 at the two locking devices so as to set the locking devices at a locked state or an unlocked state. A connecting dock 12 and a driving knob dock 13 are provided at the driving knob 11. The driving knob 11 can be conveniently replaced although it is liable to be damaged due to the frequent operation.

An alternative structure of the locking device comprises magnets respectively provided at the side bar 1 of the window screen and at the sash frame 2. When the sash frame 2 is pushed towards the side bar of the invisible windows screen, the magnets at the corresponding places magnetizes each other which makes the invisible window screen and the sash be connected and move together. In this case, it is required that the magnetism between the two magnets should be greater than the elasticity of the spring at the reel of the invisible window screen. The locking or trip device with this structure is quite simple. When the window screen is not needed, the magnets can be readily removed.

The above structure with the presence of magnets still causes certain inconvenience in use. To make it more convenient, a magnet with a magnet dock can be provided at the side bar 1 which can slide with respect to the side bar 1, or at the sash frame 2 which can slide with respect to the sash frame 2. When the window screen is not needed, one of the magnet docks can slide for a certain distance to stagger the two magnets which enables the two magnets to be separated easily.

Still another embodiment of the locking device of the invention is shown in FIG. 7. A via hole 14 is provided at an outside of the sash frame 2. An approximately L-shaped locking hook 16 is provided within the inner chamber of the window frame through a fixing pin 15. A spring 17 is also provided at the fixing pin 15. A locking buckle 18 is provided at the side bar 1 of the window screen. When the sash frame 2 is pushed, the locking hook 16 is locked with the locking buckle 18 at the side bar 1, which enables the sash frame 2 and the side bar 1 to be connected and to move together. When the window screen is not needed, pushing a handle 19 of the locking hook 16 which is protruded out of the via hole 14 will release the locking hook 16 from the side bar 1. And at the same time, the sash frame 2 can be moved. This embodiment has a simple structure and is convenient to use. The locking operation is carried out automatically and the unlocking and moving of the sash frame can be carried out in one operation.

The side bar 1 in the above embodiments can be integrally formed with the window screen where the side bar 1 can be formed as a frame of the window screen, or separately provided with the window screen where the side bar can be provided in different lengths depending on conditions in use. The side bar 1 can be connected to the window screen frame fixedly or releasably. For the releasable connection, a protruding bar at the side bar 1 can be provided to be embedded into the window screen frame.

1. An automatic trip device for a window screen comprising a side bar of the window screen and a sash frame, wherein a locking device is provided at the sash frame (2) so that the sash frame can be locked with the side bar.

2. The trip device of claim 1, wherein at least one locking device is provided.

3. The trip device of claim 1, wherein the structure of the locking device comprises a turning switch having a strip-shaped turning block at one end thereof, the turning block being inserted into an inner chamber of the sash frame through a via hole at the sash frame, within the inner chamber being symmetrically provided two hook bodies, and a repositioning spring being provided between each of the hook bodies and the sash frame.

4. The trip device of claim 1, wherein there are provided two locking devices.

5. The trip device of claim 4, wherein a connecting rod is provided that is movably connected to a protruding member at the turning switch, and at the connecting rod is provided a driving knob to drive the turning switch.

6. The trip device of claim 5, wherein a connecting dock and a driving knob dock are provided at the driving knob to connect the driving knob to the connecting rod.

7. The trip device of claim 1, wherein the locking device comprises magnets provided at the side bar of the window screen and at the sash frame, respectively.

8. The trip device of claim 7, wherein a magnet with a magnet dock is provided at the side bar which is slidable with respect to the side bar, or at the sash frame which is slidable with respect to the sash frame.

9. The trip device of claim 1, wherein the locking device comprises a via hole provided at an outside of the sash frame, an approximately L-shaped locking hook provided within the inner chamber of the frame through a fixing pin, a spring provided at the fixing pin, and a locking buckle provided at the side bar of the window screen.

10. The trip device of claim 1, wherein the side bar is integrally formed with the window screen or separately provided with the window screen.

11. The trip device of claim 2, wherein the structure of the locking device comprises a turning switch having a strip-shaped turning block at one end thereof, the turning block being inserted into an inner chamber of the sash frame through a via hole at the sash frame, within the inner chamber being symmetrically provided two hook bodies, and a repositioning spring being provided between each of the hook bodies and the sash frame.

12. The trip device of claim 2, wherein there are provided two locking devices.

13. The trip device of claim 12, wherein a connecting rod is provided that is movably connected to a protruding member at the turning switch, and at the connecting rod is provided a driving knob to drive the turning switch.

14. The trip device of claim 13, wherein a connecting dock and a driving knob dock are provided at the driving knob to connect the driving knob to the connecting rod.

15. The trip device of claim 2, wherein the locking device comprises magnets provided at the side bar of the window screen and at the sash frame, respectively.

16. The trip device of claim 15, wherein a magnet with a magnet dock is provided at the side bar which is slidable with respect to the side bar, or at the sash frame which is slidable with respect to the sash frame.
